(19) United States
(12) Patent Application Publication
(10) Pub. No.: US 2007/0179932 A1
(43) Pub. Date: Aug. 2, 2007

(54) Method for finding data, research engine and microprocessor therefor

(76) Inventor: Alain Nicoles Piaton, Paris (FR)

Correspondence Address: Alain hicolas Piaton, 6 Square Alboni, Paris, 75016, FR

(21) Appl. No.: 10/593,660

(22) PCT Filed: Mar. 18, 2005
(86) PCT No.: PCT/FR05/00659

§ 371 Date: Sep. 20, 2006

(30) Foreign Application Priority Data
Mar. 23, 2004 (FR) 04 02939
Sep. 2, 2004 (FR) 04 09271
Mar. 16, 2005 (FR) 05 02604

(51) Int. Cl. G06F 17/30

(52) U.S. Cl. 707/3

(57) ABSTRACT

The invention concerns a method for finding data in documents stored in an electronic memory comprising the following steps: selecting at least one document among the stored documents, based on a request including at least one predetermined character string; extracting a result for display in the form of a summary of data concerning the selected document; and prior to the steps of selection and extraction, generating a table representing the stored documents, comprising a character string including at least part of the data of the stored documents. During the extraction step, a result is generated using the representation table, based on data contained in the character string of the representation table considered relevant in accordance with the request.

The present invention is about a method for searching information in documents stored in electronic memory. The invention is also about a microprocessor to implement this method and a search engine.

More precisely, the invention is about an information search method including the following steps:
selection of at least one document among the stored documents, from a query composed of at least a predetermined character string, then
extraction of a result in order to display it in the form of a preview of information related to the selected document, and
prior to the steps of selection and extraction, generation of a table representing the stored documents, composed of a character string including at least a part of the information of the stored documents.

Such a method is known. Indeed, faced with the multiplication of documents in the form of files produced by word processing or electronic mail software, the necessity to have an information search method that allows finding a document rapidly is more and more widespread. New software already allows searching for text information in all types of documents, including in e-mail messages attachments. In order to do this, a table representing the stored documents, generally called an index, allows getting, for each of the stored documents, a list of keywords representative of this document and from which the document may possibly be selected on the basis of a query.

However, in spite of this, the search times are still substantial, because when a document has been selected, it is often necessary to open the document with the viewing software that is associated to it, to make sure it is indeed the requested document. Even worse, when a dozen of documents have been opened (word processing documents, spreadsheets, e-mail messages, etc.) it becomes difficult to switch from one to another.

The invention aims to remedy to these inconveniences by providing an information search method allowing the user to view rapidly and efficiently the contents of documents selected in answer to a query he has formulated.

Therefore, the invention is about an information search method of the above type, characterized in that, during the extraction step, one generates the result with the help of the representation table, from information contained in the character string of the representation table found relevant according to the query.

Thus, to view the contents of the selected documents, it is not necessary to open them, since the relevant content is directly extracted from a representation table common to all the documents.

Preferably, during the selection step, one compares the predetermined character string of the query to the character string of the representation table, notably by scanning the representation table sequentially, to select at least one document among the stored documents.

Thus, the representation table is used as an index table of the stored documents, as well. It is used both for viewing the documents contents and for searching these documents from a query composed at least by a predetermined character string. The sequential scanning of the character string contained in the representation table allows to appreciably the efficiency of the search.

Optionally, at least one stored document being of e-mail message type and composed of several distinct sections chosen among a set made of: a sender address, a recipient address, a message header, a message body, and at least an attachment, the character string in the representation table contains at least a part of the text type information of each section of the document of type e-mail message.

Thus, one may do a search in a set of stored e-mail messages taking into account not only the contents of the e-mail messages but possibly the contents of the documents attached to these e-mail messages or other parts of the e-mail messages, such as headers, as well.

In this case, for a document of e-mail message type, one may scan sequentially the information from the attachment before the information from any other section of this document.

Indeed, it is often the case that attachments of e-mail message carry the most relevant information.

Optionally, the character string in the representation table otherwise contains for each stored document the identification information of this document.

This, viewing and searching information may take into account this identification information.

Optionally, one stores in memory at least a part of the result of the information search.

Optionally as well, the part of the information search result stored in memory is stored in a file able to contain several search results from several searches.

In a possible mode of implementation, during the result extraction step, the method for searching information includes the following steps:
extracting the information contained in the character string of the representation table found relevant according to the query,
transmitting this information to a remote terminal by the means of a data transmission network,
   and displaying the result on the remote terminal.

During the stored document representation table generation step, one may do a conversion so that any displayable character in a zone of text type of the stored documents is encoded:
either on a byte;
or using a tag inserted in the representation table and followed by a code on a byte

In a particular mode of implementation of the invention, during the representation table generation step, one inserts in the representation table character string at least a set of data delimited by at least a tag to supplement the information included in this character string.

One may thus imagine inserting supplementary data, using predefined tags to enhance the viewing of the selected documents or to augment the performance of the information search. The insertion of this supplementary data using tags directly in the representation table character string does not deteriorate the performances of the information search.

Thus, for instance, the set of data includes presentation data to enhance the preview, used during the result extraction step.

The supplementary data is for instance typesetting information allowing to enhance the viewing of the selected document contents, notably to stay close to the typesetting of the content as it was presented in the document itself.

The set of data may as well contain data to help in selecting at least one document.

One may thus imagine inserting supplementary data using tags for accented character, synonyms, phonetic writing, and so on. Thus this selection help data allows selecting documents containing at least a character string similar to the predetermined character string defined in the query.

Moreover, a method for searching information according to the invention may contain one or several of the following characteristics:
each tag inserted in the representation table character string contains at least one escape character coded on one byte not in the printable characters of the first 128 positions of the ASCII encoding table.
One inserts in the representation table character string at least one information zone of numeric type coded on a predetermined number of bytes delimited by at least one tag indicating this numeric zone,
The numeric zone indication tag is moreover a tag indicating a presentation convention of this numeric zone,
The stored documents being distributed in different types of documents, one defines for each type of document a set of tags intended to be inserted in the representation table character string, each tag in this set having a meaning specific to this document type
One inserts in the representation table character string at least one set of data expressed in phonetic writing delimited by at least one tag indicating phonetic writing,
One inserts in the representation table character string at least one tag indicating that a predetermined number of characters following this tag in the representation table character string could not be examined during the selection step,
One inserts in the representation table character string at least one set of data corresponding to a grammatical analysis of a part of the contents of at least one stored document, delimited by at least one grammatical analysis indication tag.
One inserts in the representation table character string at least a set of data corresponding to description metadata of a part of the contents of at least one stored document, delimited by at least one metadata indication tag.
One inserts in the representation table character string at least one tag to start a predetermined program.

Moreover, an information search method according to the invention may contain a characteristic according to which:
Each stored document containing information distributed under several distinct predetermined sections common to all the stored documents, the result is displayed in the form of a preview that includes a preview zone for each distinct common section, and includes a list of documents initially selected because of information they contain found relevant in relation to the query.
Each preview zone may be disabled, and
When at least one preview zone is disabled, one maintains only in the displayed list each document initially selected because of information found relevant that this document contains under at least one section corresponding to a preview zone remaining enabled.

Using these supplementary characteristics, the information search method allows the user to do a rapid choice in a set of selected documents provided as answers to his query.

The invention is also about an information search engine for documents stored in electronic memory, including:
Means for generating a table representing the stored documents, this table including a character string containing at least a part of the information of the stored documents,
Means for selecting at least one document among the stored documents, from a query containing at least one predetermined character string,
   Characterized in that it comprises means for extracting a result using the representation table, from the information contained in the character string of the representation table found relevant in relation to the query, so as to display this result in the form of a preview of information relative to the selected document.

Finally, the invention is about a microprocessor with instructions programmed for implementing an information search method such as defined above.

According to the invention, a microprocessor may moreover comprise means of storing at least one dictionary table containing a set of words in a predetermined language, each word being associated in this dictionary table to grammatical analysis data.

The invention will be better understood with the help of the following description, given solely as an example and referring to the graphics shown in the appendices, in which:

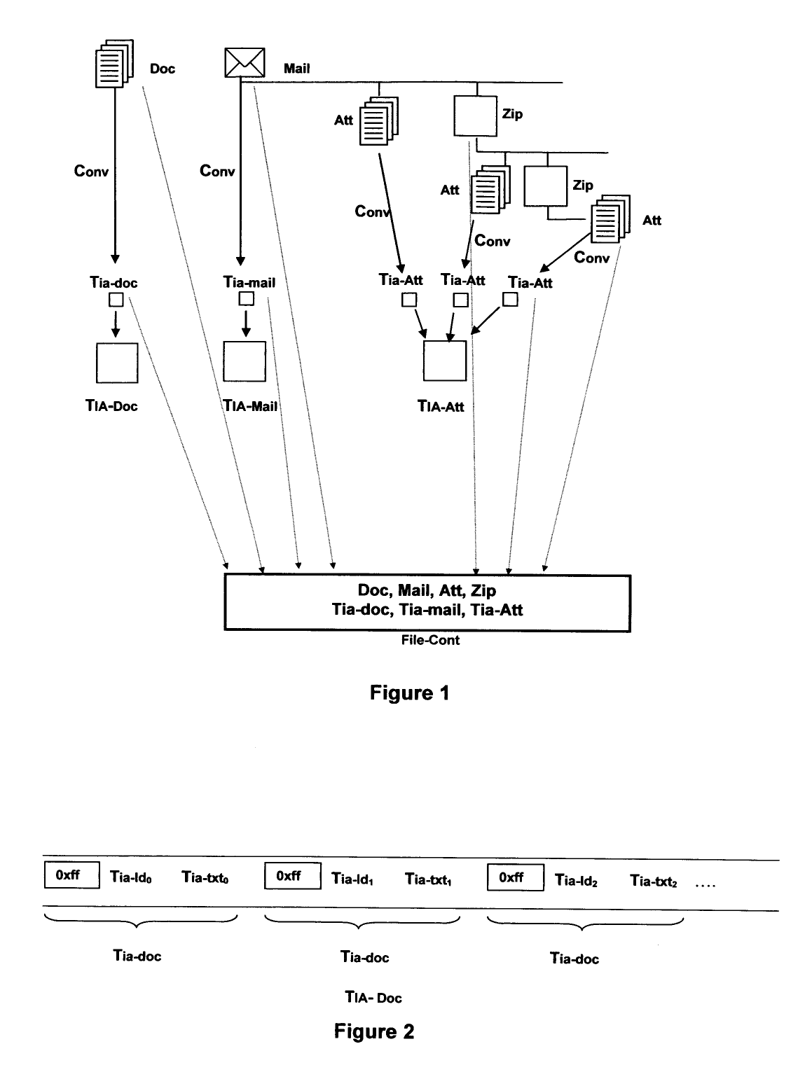

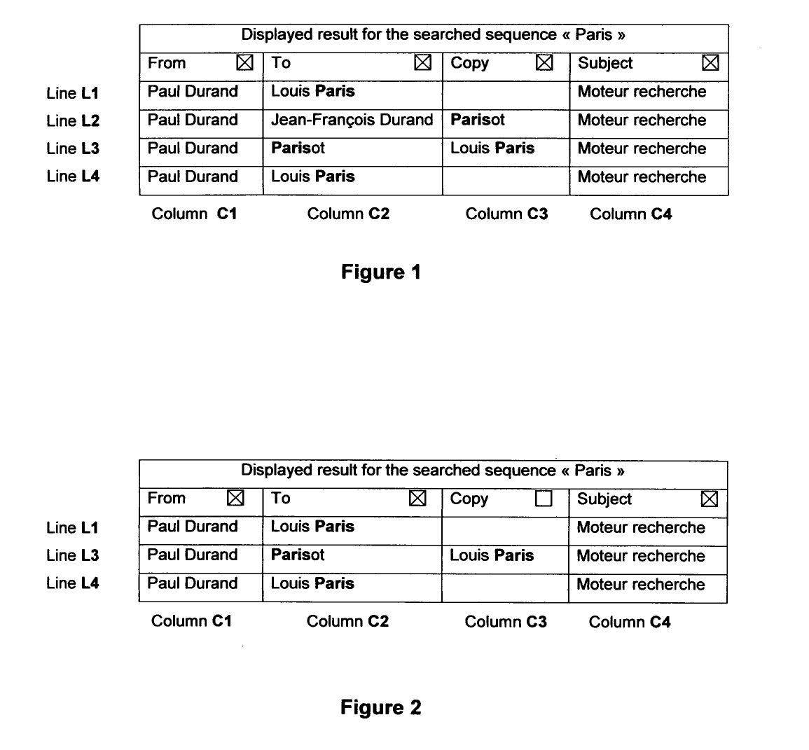

The FIG. 1 represents a diagram of the successive steps to be carried on for the generation of a table representing the stored documents, in an information search method according to the invention;

The FIG. 2 represents a diagram of a sample character string contained in the representation table shown in FIG. 1;

FIGS. 3 and 4 represent viewing windows of a selection of documents, displayed during the carrying out of a particular mode of implementation of the invention

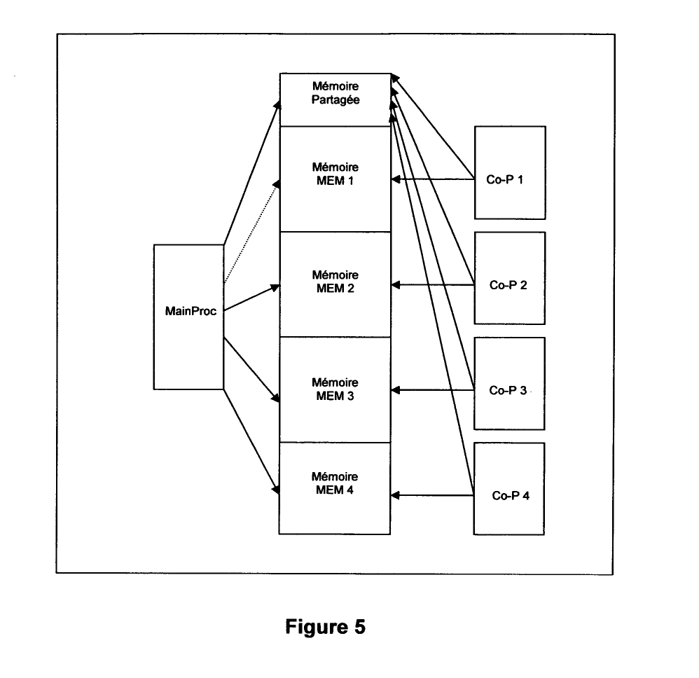

FIG. 5 represents the diagram of a device including a master microprocessor and several coprocessors for rapid execution of a method according to the invention.

As it is represented in FIG. 1, a method according to the inventions uses the following elements:
A set of documents on which one may perform searches, namely all types of documents containing text such as word processing documents, spreadsheets (labelled Doc), or e-mail messages (labelled Mail) possibly with attachments (labelled Att, Zip), these documents being stored either on a computer from which the searches are run, or in enterprise internal networks, or external and available through the Internet
A set of stored documents representation tables, to perform the searches, and
A set of stored documents representation tables, said previews tables, to allow a rapid display of the results.

In a preferred mode of the invention, the same tables are used to perform the search and display the previews, i.e. the index tables are used as stored documents representation tables to display the previews. Thereafter these tables will be called index and preview table (labelled TIA.)

A search method according to the invention requires the following steps:
Generation of an index and preview table (i.e. a stored document representation table) containing at least a part of the stored document information,
Searching documents by selection of at least one document among the stored documents, from a query containing at least one predetermined character string,
Displaying a result in the form of a preview of information related to the selected documents.
   Generation of the Index and Preview Table

The index and preview table must allow a rapid search and a rapid display of the preview. It contains for each document the two following types of information:
On one hand, the complete or partial contents of the document in text format, uncompressed, i.e. any element that can be displayed in text form (in the case of e-mail messages the contents of the attached documents, be it compressed or not, is as wall memorized in the index and preview table.)
On the other hand, elements identifying the document such as the name of the document, its subject, a date, its length, keywords, an access path to the document on a hard disk, etc. (for e-mail messages, the sender name as an e-mail address and alias, the recipient names, carbon-copy, a folder name, etc.)

All the documents are stored one after the other either in a unique index and preview table, either in several index and preview table, one by document type for instance (labelled TIA-Doc TIA-Mail.) As represented in FIG. 2, each document such as TIA-Doc is represented by a header (labelled TIA-Id) followed by all the fields in text format (labelled TIA-txt) likely to be selected during an information search.

In a preferred implementation mode of the invention, one uses a system of separators between, the different documents, and between the different elements inside each document, so as to allow to rapid scan of the index and preview table.

The TIA-Id header gathers the numerical type data, as well as the texts on which no search is performed:
A separator character ‘0xff’ or any other character than can not be part of a text file, located at the beginning of the header,
The header length
Numerical data such as blocks lengths, various counters,
Numerical data likely to be searched, called hereafter sections, such as the length of the document date
Alphabetical data the does not belong to the search fields (computer name, customer, language, conversion tables, etc.)

Next one finds a text part (labelled TIA-txt), comprising all the elements on which the text-format searches are performed. It is the contents, keywords, identification elements of the documents. These different elements, hereafter called sections, are stored one after the other in text form, and are separated by separator characters.

In a preferred implementation mode of the invention, the contents of each e-mail attachment is memorized in a separate index and preview table (labelled TIA-Att) said attachment index and preview table and any given document appears only once, even if it belongs to several e-mail messages or several compressed Zip files themselves attached.

The index and preview tables are generated then periodically updated thanks to converters (labelled Conv) that, from the original documents (word-processing, spreadsheets, presentations, e-mail messages . . . ) extract all the useful elements for the consultation of these tables at the information search time, then for the display of the results in the form of previews.

Document Searches.

Except for information retrieval or Internet search engines that are very fast when they use a thesaurus, in general, the desktop search software start by scanning a file index table on the computer's hard disk, commonly called FAT, or an equivalent table that allows verifying of the file name, type, length or date satisfy the search criteria. If it is the case, and in the case where one must perform the search on words contained in the documents themselves, one then scans sequentially the contents of each document that match these first search criteria, to check that the searched words are present in the document. This technique, consisting in first exploring an index table, and if necessary a second table containing the texts themselves, is much slower than the one consisting in scanning sequentially an index and preview table that contains all the contents of the documents, as described below.

To perform a search on one or several words or parts of words, one scans sequentially the index and preview table as follows:
When a document separator is met (equal to 0xff), one analyses the elements of the TIA-Id header of the document that follows then one sets the position on the first character of the TIA-txt zone corresponding to the elements on which one wants to perform the text-format search in this document,
Then, one scans the TIA-txt zone to check if it contains a part or the totality of the searched words. If it is not the case, one goes to the next document, else the count of the number of separators allows determining what the current section is, and thanks to the data in the previously loaded header, one has all the necessary elements to display the search results.

In a preferred mode of implementation of the invention, one begins by scanning the TIA-Att attachment index table and, each time an attachment matches the search word or words, one memorizes temporarily in a table an identifier of this attachment, allowing, next, during a scan of the TIA-Mail e-mail messages table, to identify the messages that have attachments containing the searched words.

In the case where one searches information in documents, from a query composed of two predetermined character strings, one may proceed in two different ways:
Without document duplication: during a first phase, one starts the search by scanning the totality of the representation table, and one memorizes the documents addresses that contain the first of the two predetermined character strings, then during the second phase, one starts the search by scanning only the documents of which one has kept the address, to select those that contain the second predetermined string; or
With document duplication in a new secondary table said “secondary representation table”: during a first phase one starts the search by scanning the totality of the representation table, and by duplication, one creates a secondary representation table from the documents that contain the first of the two predetermined character strings, then in the second phase, on start the search by scanning on the new secondary representation table that one just created, in order to select the documents that also contain the second predetermined character string.
   Result Display

Information relative to the selected documents at the end of the search are displayed in the form of a table said found documents table and several columns each correspond to one or several of the said sections.

When a table row is selected, for instance an e-mail message, the TIA-txt contents of this message is extracted from the index and preview table then displayed in a separate window said preview window. When one goes to the next row in the table, it is the contents of this new e-mail message that is displayed in the preview window. When an e-mail message contains one or several attachments Att, the name of the attachments is displayed on the screen, and when one selects one of them, its API-Att contents is extracted from the attachments table and displayed in the preview window, with no need to execute an information presentation software (word-processing documents, spreadsheets, . . . ) associated to it.

This operation is extremely fast, since the displayed content is part of the table that is explored during the search step.

Starting at least one search, then selecting the only useful documents in order to deal with a problem, represents an operation costly both in time and skills, i.e. such a selection brings added value compared to the raw initial information. With current e-mail technology, if one wishes to transmit this information to another person, all the documents will be transmitted in the form of message attachments, and the recipient will have to do again part of the selection work that has already been done.

This is why it is preferable to transmit a folder called hereafter <<container-file>> (labelled File-Cont) that contains not only the original documents (word-processing, spreadsheets, e-mail messages, . . . ) but also all the elements that will allow this person to recover all the classification work that had been added by the original search author.

To achieve this, it is sufficient to have a container-file into which, with a copy-paste function, one can copy one or several rows of the found documents table. Thanks to this operation, one memorizes in a persistent memory, all the information related to each table row, that is, the contents of the original document with its typesetting, the drawings, images, audio, animations, etc., the TIA-txt necessary to display the preview, and all the information the original user will have added to this initial information to make reading it faster, and its presentation more relevant (for instance search criteria, column sorting modes, or the way to order the found documents table rows, search statistics . . . )

This container-file, following the example of a mail folder, may be transmitted to another person either in the form of a file through an internal enterprise network, or in the form of an e-mail message attachment. The recipient will be able to see the contents of this container-file, displayed as an array, in a similar way to the found documents table, each row of the container-file corresponding to a row of the table of found documents. In the same way, thanks to the preview display window, it is also possible to see rapidly the contents of the documents contained in the container-file (e-mail messages, word-processing, spreadsheets . . . ) without needing to open the documents with the presentation software associated to them.

The container-file may in its turn be modified or enriched with other documents, then transmitted to other recipients. When it is used as an e-mail message attachment, it may, in its turn, be explored by the search engine, and the results of the search may be inserted in a new container-file.

The information relative to the documents found at the end of the search are displayed in the form of a preview that includes a preview zone for each section and includes a list of documents initially selected for the information they contain found relevant according to the search.

More precisely, they are displayed for instance in the form of a table comprising on or more rows for each selected document and several columns each corresponding to one or several said sections.

FIG. 3 shows a sample search result in e-mail messages in which rows R1, R2, R3 contain a sequence of search characters “Paris”.

The title of each column includes at the same time the corresponding section title and as well as a checkbox or an equivalent device working as follows:
If the checkbox is checked, the column is activated and all rows that contain the search word or words in the section corresponding to the column, are displayed,
In the opposite case, the rows that contain the word or words only under the section corresponding to the column are hidden.

In the FIG. 3 example, among the lines that contain the relevant information, in this case the sequence “Paris”, one displays only the rows that contain the searched sequence in at least one of the active columns, which is different of the classical tab device consisting in the display of only the rows that contain a searched sequence in a given section.

In this way, simply by checking or unchecking a column, it is possible to display only a part of the rows corresponding to the search result.

In FIG. 4, the C3 column is disabled to hide all the e-mail messages in which “paris” was simply in carbon-copy: the row R2 does not appear anymore, on the other hand the R3 row is still displayed because “paris” appears in column C2 of the R3 row.

Nevertheless, the method described above may again be improved to address several problems.

Display in the preview window shows only the plain text of a selected document, exactly as the e-mail messages in plain text format, that is without typesetting elements, or color, or underlined or bold words, whereas is may be desirable to display these previews with an improved presentation, close to or equivalent to the original presentation of the selected document.

In addition, this method does not offer all satisfaction when one does searches on words with accents: indeed if one searches the word “amélioré”, the document containing only “améliore” are not detected.

In some cases, one equally wants to find documents from a synonym, or an equivalent notion, for instance <<finance>> instead of <<financing>>

In yet other cases, when one deals with amounts, one wants to be able to find a document that contains <<1,000>> when one searches <<1000>>, or the reverse, and this whatever is the decimal separator convention (some use the dot instead of the comma.) In the same manner, one wishes to easily distinguish between the number 1000, and a number that contains the same digits like 10001, or between a number that corresponds to an amount or a product code or an account number.

Finally, in other cases, one wishes being able to reconstitute the original text document from the stored documents representation table, for instance reconstitute a document generated in RTF format or an e-mail message in HTML format, so as to reduce the space used on the disk, or for working on a unique information instead of a replica added to an original information, which is much more simple and secure for all data processing.

In a general way, it is useful to have in the stored documents representation table, in one form or another:
All the elements allowing to reconstitute the original information,
The elements allowing to handle approximations due to spelling, accents, currency symbols, number rounding, and allowing to use known document analysis techniques,
Elements related to the nature of the information (amount, counters, account number, product code, pointer to a parent or a child element, etc.) to be able to use this kind of table in applications without relation to information retrieval.

For a number of supplementary information, the best solution consists in adding a whole series of fields near the plain text.

On the other hand, for others it is preferable to use a codification system in which the information in intimately tied to the text itself, thanks to a system of tags analogous to the one found in the HTML or RTF formats coding.

By definition, a tag is composed of at least one escape character, preferably out of the printable characters in the first 128 positions of the ASCII encoding table, such as 0x1 (hexadecimal notation), 0x2, 0x80, . . . (this character contains both a notion of tag type and a notion of tag length.) Optionally, it can also include one or more characters, preferably different from the null 0x0, which is traditionally reserved to the end of a character string.

To address the different types of above mentioned problems, one uses four tag types called respectively:
Typesetting tags,
Advanced search tags,
Process launching tags,
Formatting or alert tags.

To simplify the presentation, one has retained this partitioning by categories, but according to the usage type, one may appeal to such or such tag type.

Typesetting Tags

These tags are used to insert typesetting information. For instance to display the word <<horizontal>> one will use the sequence:
<<h-o-0x8-G-r-i-z-0x8-U-o-0x8-g-n-t-0x8-u-a-l>>,
In which:
The escape character <<1x8>> means <<start or end tag>> with a tag length of two characters (including the escape character),
The next character <<G>> corresponds to <<start bold>>, <<g>> to <<end bold>>, <<U>> to <<start underline>>, <<u>> to <<end underline>> (the << >> characters have been added to ease comprehension, but do not appear in the stored documents representation table string).

Tags of this type may also be used to change the character font, the font size, indent paragraphs, change the interline space, indicate a new page, and so on. In this way, a set of tags using 2, 3 or more characters, allows, starting from a MS Word or Acrobat Reader Pdf document, to create a sequence of characters that allows at the same time:
Fast scanning, as it is specified below,
Generating a file in the RTF format appreciably equivalent to the original document, which in most cases dispenses with having to keep the preview table and the original document.
One will note that MS Word, Visual C++, WinSdk, MSN, RTF are formats and trademarks or Microsoft Inc. Acrobat Reader Pdf is a trademark of Adobe Inc.
   Advanced Search Tags

1) Using Tags for Accents.

It is useful to be able to perform a search on a word while taking into account the accents. For instance, if one starts a search with the word “andré”, it is useful to be able to find the documents that contain the word without accents, for instance an e-mail address such as andre.dupont@xxx.com or with a spelling mistake: “andrè”.

One may encode this information in the following wa:
<<a-n-d-r-é-0x7-e-0x7-\grave{e+EE>>,}
The <<0x7>> tag meaning that the next character (<<e>> or <<è>>) is equivalent to the previous (<<é>>).

2) Using Tags to Repeat n Times the Same Character.

It may be equally useful to compare 2 character strings contaning space characters, as in the following example:
<<moteur de recherche>> and <<moteur de recherche>>.

One may solve the problem with tags in the following way: first, in the character string to search, one replaces the space character sequences by a single space character or by the non-displayable character 0x1, and in the character string to be scanned, one does the following conversion:
For space characters sequences of length inferior to 6 characters, one uses tags encoded by a single character, namely 0x1, 0x2, 0x3, 0x4, 0x5 (without any characters following) with allows with a single character to solve this very frequent problem when a text is right and left justified.
For longer sequences, one may use a classic convention such as: 0x6—sequence length—repeated character.

3) Using Tags to Accelerate Content Analysis.

When one wants to analyse a text, one must start with a certain number of operations like grammatical analysis, and memorize the result of this analysis with tags, so as to obtain verbs in infinitive form, names in singular form, articles, conjunctions, and so on.

For instance: <<le printemps est chaud et sec>> may be encoded:
<<0x1-l-e>> 0x1=article
<<0x2-p-r-i-n-t-e-m-p-s>>0x2=singular common name
<<0x4-P-3-ê-t-r-e>> 0x4-P-3=verb present tense 3rd person
<<0x7-c-h-a-u-d>> 0x7=singular adjective
<<0x8-e-t>> 0x8=conjunction

Insofar as the table scanning software may be made extremely fast as we will see below, one may use a table said “dictionary table”, or a set of tables containing all the possible words in a given language to check that each word in a document exists, and perform its grammatical analysis.

Such a dictionary table would contain a sequence of blocks comprising one or two elements according to the complexity of the word to be analysed. For instance:
<<0x1-l-e>> 0x1=article
<<0x2-p-r-i-n-t-e-m-p-s>> 0x2=singular common name
<<c-h-e-v-a-u-x-0x3-c-h-e-v-a l>> 0x3=plural common name
<<e-s-t-0x4-P-3-ê-t-r-e>> 0x4-P-3=verb present tense 3rd person
<<0x7-c-h-a-u-d>> 0x7=singular adjective

For regular verbs, one may have:
Either all the possible conjugation forms, as
   <<i-n-v-e-n-t-e-r-a-s-0x4-F-2--i-n-v-e-n-t-e-r<<, future tense 2nd person,
Or a more compact form associated to a conjugation rule, as
   <<i-n-v-e-n-t-0x5-R-1--i-n-v-e-n-t-e-r>>, first group regular verb.

In this way, the representation table will be enriched with tags and words allowing to perform more easily other content analysis, this enrichment being done at the representation table element creation time, or at the “secondary representation table” creation time.

In addition, when one wants to analyse the contents of a document of text type, the orders of the words is important, as in the example <<location de voiture>> or <<voiture de location>>. This sometimes requires scanning the text several times.

Rather than restarting the scan from a previously stored address, another solution, as seen above, consists in creating a secondary representation table and in duplicating the document. To make the analysis easier, it may be judicious, at duplication time, to insert tags analogous to the ones described above to ease content analysis.

One may as well consider a system where one generates a whole set of secondary representation tables, be it for a document, be it for a set of documents that contain a predetermined character string or tags of a given type.

4) Using Tags for Metadata.

Internet search engines generally proceed the following way:

When a new document must be added to a database, one starts with the analysis of its contents by using different techniques, among which one consists in grammatical analysis, as described above; then the result of this analysis consists in the creation of a list of keywords or metadata attached to this document. These are the metadata which are placed in what is commonly called an inverse index, and that are looked up when a use provides several criteria for searching for a document.

Metadata of this type may be encoded by the means of a tag system as in the following examples:
<<0x14-2-3-é-t-a-l-o-n>>.

The 0x14 tag and the following 2 characters (2-3) allows to indicate the word and to associate it with a concept such as <<23=animal>>.
<<0x15-1-3-r-e-f-i-n-a-n-c-e-m-e-n-t-0x15-f-i-n-a-n-c-e-r>>.

The 0x15 tag is of a similar nature and furthermore allows associating a concept such as the action of financing.

In this way during the initial creation, or later during the creation of a <<secondary representation table>> it is possible to add to a document a whole series of metadata to allow intelligent search on the contents.

5) Using Tags for Phonetic Writing.

If one wants to interface the search with a speech recognition module, or to ease automatic analysis, it is useful to

Si on veut interfacer la recherche avec un module de reconnaissance vocale, ou pour faciliter l'analyse automatique, it is useful to resort to phonetics. In a given language, there is generally an equivalence between the words and the way to pronounce them, but it is not always the case, as the word <<parent>> if it is about <<père>> or the verb <<parer>>. In the same way, to the same sounds may be associated to several spellings particularly with proper names like <<Durand>> and <<Durant>>. To raise this dilemma, after each word that poses a problem, one may put a tag to indicate the equivalent in phonetic writing.

6) Using Tags for Amounts.

According to the language, 1000 monetary units is written in different ways: in french, <<1.000,00>>, ou <<1.000>>, in english <<1,000.00>>, etc.

If the user is French or American, he will start the search with <<1.000,00>> or <<1,000.00>> or simply <<1000>>. One may use a system of tags that takes this particularity into account:
<<0x3-1-0-0-0-0-0-0x4-1-.-0-0-0-,-0-0-0x5-1-,-0-0-0-.-0-0-0x6>>.

The 0x3 tag indicates that the following field is an amount expressed in cents.

The 0x4 tag indicates that the following tag is an amount displayed with European conventions.

The 0x5 tag indicates that the following field is an amount displayed using American conventions.

The 0x6 tag indicates the end of the zone related to this amount.

One may also add a tag indicating which convention is used in the original document.

This system of tags allows to restore the original document formulation, and to find the amount whoever is the user starting a search.

7) Using Tags for Dates and Times.

One solves in an analogous way the problem of date and time that are displayed in different ways according to the language, the time zone, displaying without time, and so on.

8) Using Tags for Numbers.

In an analogous way, one may use a tag such as 0x1C to indicate that the next four characters correspond to an integer number encoded in binary on 32 bits. In this case, the zone to compare will not be a character string, but an integer number encoded on 32 bits. It must be noted that in this precise case, each off the four characters that follow the tag may have any possible value, including the binary zero that usually denotes the end of a character string.

This coding mode may be used for any numeric information type, signed or not, on 16, 64, 128 bits, in floating point, and so on. Comparison between two zones may consist in testing equality between these two zones, but in a general way, one may perform all logical operations between two zones (less than, greater than, logical inclusive or, exclusive or, and so on.)

It must be noted as well that being about amounts, according to the case, one will memorize the information:
Either in text form, as explained above.
Or in numerical form, that is:
   A tag indicating a currency (dollar, euro, or other),
   A tag specifying the display convention (European or Anglo-saxon),
   A tag preceding an integer encoded on 32 bits,
   Finally, a number expressing the amount in cents.

It goes without saying that for most frequent cases, a single tag may replace the 3 tags described above.

In the case where information is in numerical form, to begin with one must convert the user query from a text format to a numeric format, so as to be able to perform the comparison at high speed, character by character.

An amount is a zone of numerical type, but there are others. Thus, it is the same for dates that may be memorized either in text form, or in number form, according to the usual conventions used in computing. Tags may specify the display mode, the fact that it is a local time date, or better in Universal Time. Process launching tags.

1) Using Tags to Start an Analysis Process.

In a document, some words have a more important meaning than others if one wants to perform an analysis of its contents. One may highlight these words by a system of tags of the type:
<<0x16-2-3-f-a-i-l-l-i-t-e-0x16>>,
The 0x16 tag and the next 2 characters (2-3) allow at the same time to indicate the word and to associate it with a concept such as <<23=juridique>>.

A correlation between the criteria provided by the user and the presence of some words in the document may activate a content analysis process.

2) Using Tags to Start Other Programs.

For instance if one wants to protect sensitive information, one may use a tag such as:
<<0x17-p-a-s-s-w-o-r-d-1-0x17>>,

the 0x17 tag framing the call to a type 1 authentication, according to which the current information block is ignored or analysed.

In a general way, it is a means of starting a sequence of instructions that are executed in the same program, or in another program residing on the same computer or on a remote computer, allowing the operation mode to be either cooperative, parallel, according to usual programming techniques.

Formatting or Alert Tags.

One may consider that a character string may contain at the same time a text to display, information to display it with a presentation similar to the one offered by word processing tools, elements to help the search, information to start software.

Some words marked by tags, may be grabbed on the fly, and duplicated in a memory area to be processed later for content analysis and allow a more relevant search.

In a more general way, one may use tags to give particular meaning to some fields, such as an account number, a quantity, an amount, a date, a product code, a pointer to an object, a hierarchical concept, of parent, child, sibling, that is all notions that one may find in a table or a file in a computer containing a succession of records of different types. Here by <<record>> we mean documents stored in the computer.

One may use a whole set of tags for a record such as a bank operation, then use tags with the same values expressed in binary, but with a completely different meaning for a record corresponding to a stock of goods.

This, each record type, that is each type of document stored in the computer, may be associated to a set of tags with specific meanings.

During a complex operation, for instance to print a bank account statement, utilizing different information such as the name and address of the bank account holder, the list of all movements in a time frame, one may be brought to consult several different stored document representation tables, and the meaning of the tags may change during the different phases of this operation.

One way to solve the problem, is to memorize, either at the representation table itself, or at the level of each record of the representation, an information (or a code) allowing to know the meaning of any set of tags that must be used at a given moment.

One may also use a tag followed by a 32 bits numerical zone corresponding to a length L to indicate that the next L characters correspond to a zone without text, for instance an image in such or such format, a sound, a sequence of images, a zone compressed or coded in “.zip” format, a byte sequence, a MS Excel type spreadsheet, and in general a sequence of characters on which no search is performed.

One may also use tags to delimitate different encoding zones.

In the western world, and particularly in the anglo-saxon world, almost all the displayable information is encoded on one byte. Contrarily for languages such as Arab or Chinese, or for a few characters such as the Euro, one uses the Unicode standard.

In occident, one may suppose that by default the encoding uses a single byte, except between a Unicode start tag and a Unicode end tag.

In the same spirit, on 8 bits, that is a byte, one may code the 160 characters of the latin alphabet (10 numbers, 2x26 letters, 2x6x4 accented vowels and about 50 special characters) and have a hundred tags. The Unicode encoding may be replaced by another encoding, more compact and more adapted to this usage.

If there are too many combinations to encode both the characters to display and the tags on a single byte, that is more than 256 possibilities for an 8 bits character, one may use, for the least frequent characters, for instance fractions, a tag indicating that the next character belongs to a second character set; it must be noted that this system is different from the Unicode system, that systematically uses 2 bytes, allowing 65536 possibilities, whereas the present system allows only 256 possible characters after a tag of this type.

A representation table such as described above, that is including tags, may be used in several ways:
Start an identical search: one ignores all fields indicated by tags: this is for instance a default usage mode;
Display a document in a preview window, or reconstitute the original document: in order to do that, one will ignore all tags, except the the typesetting ones;
Start a more sophisticated search, with the ability to interpret the document: one will use all the advanced search tags, including the process launching tags useful to implement the most advanced known techniques in this field;
Finally, in a completely different domain, thanks to the whole of these techniques, use this table as a true database with fields of any nature, zones of numerical type; stored in decimal or hexadecimal, pointers, zones to start processes, and so on.

All of these possibilities may be regrouped in a small instruction set usually called API (“Application Programming Interface”).

One will find hereafter a sample non-restrictive list of this API, namely:
StrStrEx, by analogy with the <<strstr>> function that exists in most programming languages, and that consists in searching, in a character string, the next occurrence of a given substring;
ExtractEdit, to extract from a string, the text to edit with only the typesetting tags (the case where one wants the plain text without any tag is a particular cas of this one);
ExtractData, to extract data from a string to a set of fields according to the formats usually used in computing (integer on 32 bits or 64 bits, floating point format, and so on);
MakeEditStr, reciprocal operation to ExtractEdit to convert a set of text documents (such as MS Word, RTF, etc., or e-mail messages in plain text or HTML) to a representation table with typesetting tags, and possibly the ones allowing a search from content analysis;
MakeDataStr, reciprocal operation to ExtractData to convert each record in a file to a representation table element with tags allowing fast access to an element by the means to criteria;
StrStrExMultiple, making multiple calls to the elementary function StrStrEx, and allowing to process several character strings contained in a single document called multiple document so as to find one or more substrings;
InitStrStrEx, to define the list of all tags, with:
   Their values (escape character+first character+second character, . . . ),
   Their meaning and operating mode in the different usage types (search, extraction for edition, extraction for conversion, start processing, . . . ) and in a general way all the configurable elements and those required to link the tags to external programs.
      Description of the StrStrEx Function and Operating Mode.
LPCSTR StrStrEx (LPCSTR ptrStart,
   LPCSTR ptrSubChain,
   UINT uiParameter,
   STRSTREX *strExtended)
      In which:
LPCSTR ptrStart is the starting point in the string to search,
LPCSTR ptrSubChain the substring to search for.
UINT uiParameter the scanning mode,
STRSTREX *strExtended the adress of a structure allowing to specify data, conversion formats or to communicate with other processes.

The scanning mode is a set of 32 bits or more that, combined, specify how one must interpret the character string. For instance:
STREX_SKIP_BAL=−1 ignore character case and all tags,
STREX_WITH_CASE=1 match case,
STREX_SKIP_EDIT=2 ignore typesetting tags,
STREX_SKIP_ANALYSIS=4 ignore advanced search tags,
STREX_SKIP_PROCESS=8 ignore process launching tags,
STREX_SKIP_FORMAT=16 ignore formatting tags,
STREX_FAST_DUPLIC=32 duplicate some words on the fly,
STREX_ANALYSIS_{—}1=64 use type 1 advanced search tags,
STREX_ANALYSIS_{—}2=128 use type 2 advanced search tags,
etc.

STRSTREX *strExtended is the address of a structure allowing to specify data, conversion formats or to communicate with other processes, as does the BROWSEINFO structure used in the Microsoft Windows Shell API function SHBrowseForFolder (see MSDN Library Documentation).

For instance, the command <<0x17-p-a-s-s-w-o-r-d-1-0x17>> may start an authentication program indicated in a command of type “Callback”.

The returned value is:
a pointer on the next found occurrence,
0x0 if no string was found, or
A symbolic value in case of error.

To be efficient, the StrStrEx function must use the characteristics of modern microprocessors and the possibilities offered by the technology of electronic components. In particular, En particular, the use of certain functions provided in the C programming libraries is excluded.

One will note that the aim is not to have compact code, but to execute the smallest possible number of instructions in the statistically most frequent cases.

One will find in the appendix sample code written in the C language for a part of the StrStrEx function.

Description of the ExtractEdit Function and Operating Mode.

int ExtractEdit (LPCSTR ptrStart,
   LPSTR *ptrEditChain,
   UINT uiParameter
   STRSTREX_ED *strEditInfo)
      in which:
LPCSTR ptrStart is the address of a character string to extract,
LPSTR *ptrEditChain is the address of a pointer to the string to edit,
UINT uiParameter specifies the edit mode (no typesetting, typesetting for display, typesetting to restore a MS Word document in RTF format, etc.),
STRSTREX_ED *strEditInfo the address of a structure to communicate more information on the conversion mode and the format.

The ExtractEdit function uses a great part of the StrStrEx elements.

Description de la Fonction ExtractData et Mode de Fonctionnement.

int ExtractData (LPCSTR ptrStart,
   void *ptrExtractedData,
   STRSTREX_EXTRACT *strExtractInfo)
      in which:
LPCSTR ptrStart is the address of the string to extract,
LPSTR *ptrExtractedData the address of a pointer on the object to create,
STRSTREX_EXTRACT *strExtractInfo the address of a structure to communicate the format of the object to create, and all the required processing to perform the conversion.

The ExtractData function uses a great part of the StrStrEx elements.

The MakeEditStr, and makeDataStr functions are essentially conversion programs that pose no particular problem to an expert.

Description of the StrStrExMultiple Function and Operating Mode.

LPCSTR StrStrExMultiple (LPCSTR ptrStart,
   LPCSTR *ptrSubChain,
   STRSTREX_MUL *strExtended)
      In which:
LPCSTR ptrStart is the starting point in the string to search,
LPCSTR *ptrSubChain a set of substrings to search for,
STRSTREX_MUL *strExtended the address of a structure allowing to specify this function's parameters.

The returned value is:
A pointer on the next found occurrence,
0x0 if no string was found, or
A symbolic value in case of error.

The StrStrExMultiple function allows dealing with a multiple document such as an e-mail message.

An e-mail message regroups information on the sender, the recipients, the carbon-copy recipients, the subject, the contents of the message, as well as other information, and this e-mail message is stored in the preview table in the form of a header, followed by the different strings containing the sender, recipients, carbon-copy recipients, subject and message contents, said header comprising itself a start tag, and the said other information.

By using several times the elementary function StrStrEx, it is possible to determine if one or several strings of the multiple document contains a searched-for substring, and in which string. It is as well possible to determine if the multiple document contains not only one substring, but several searched-for substrings.

Description of the InitStrStrEx Function and Operating Mode.

int InitStrStrEx (STRSTREX_BALISES *strBalises,
   STRSTREX_PROCESS *strProcess,
   STRSTREX_CONV_CHAR *strConvChar,
   STRSTREX_MISC *strMisc)
      in which:
STRSTREX_BALISES *strBalises is the address of a structure specifying the escape values, of each tag, their length, categories (typesettig . . . ), their action, the links with processing, and so on,
STRSTREX_PROCESS *strProcess is the address of a structure specifying the information to perform link resolution with external or internal processing used by StrStrEx and other API functions described below,
STRSTREX_CONV_CHAR *strConvChar is the address of a structure specifying the list of used characters, Unicode, Ascii, etc., the conversion tables between these encodings, the uppercase to lowercase transition rules etc.,
STRSTREX_MISC *strMisc is the address of a structure specifying other data such as the version, languages, programming languages, operating systems (Windows, Unix, Linux . . . ), the encoding conventions (XML, RTF, MS Word, etc.), the limits of processor speed, memory size, integer size, and so on.

This function is generally called at the beginning of any execution of a program using the StrStrEx API and its derivatives.

At least a part of these functions may be regrouped in what one calls a library that can be integrated in other applications.

For instance, this library may be integrated in other applications to build a search engine based on the representation table scanning technique as described above, which has the particularity of:
Being able to integrate a preview window which content is extracted from the said table, and
Thanks to the typesetting tags, additionally offer a presentation equivalent to the original document in the majority of cases.

This library may also be integrated in other applications to build or analyse a container regrouping all of:
Documents containing text such as MS Word or Pdf, from the local hard disk or the local network of a user,
E-mail messages with their attachments, that is documents containing text (MS Word, pdf, etc.) or any document such as image, sound, etc., and
Sufficient elements to have a preview of the documents containing text, without having to open these documents with the associated program, which is obtained by inserting one of the elements of the said stored document representation table.

Thanks to an encoding with typesetting tags, it is possible to dispense with most of the documents of text type such as MS Word or Pdf, since the said table contains most often equivalent information.

One must know that Pdf and especially MS Word documents are generally 10 times bulkier than an equivalent RTF document and even more than a a file using compact tags like the one described above.

Such a saving in space is very useful, be it to save information to disk, to generate backups, to constitute e-mail archives, to transform this information on local networks or through the Internet in the form of attachments in e-mail messages. This allows many users in big companies to avoid deleting their e-mail messages older than 6 or 12 months, which is an important inconvenience to them.

This library may as well be integrated in other applications to build the different elements of messaging software to:
provide a search engine with the characteristics described above, and
Offer a new attachment system using the container described above.

This library may also be integrated in other applications to build databases containing essentially non-modifiable information as shown in the example below.

A bank has one million customers, and the whole of the e-mail messages including attachments, of letters or specific documents for one customer represents on the average twenty thousand characters (or about ten full pages). The whole of this data, with the typesetting tags, with the identifiers (agency code, account number, dates, specific texts, letters references, e-mail addresses, etc.) and the corresponding formatting tags, amount to a maximum of 32 KB.

A customer accumulates an average of twenty movements per month, and one needs about one hundred characters to describe an account transaction: agency code, operation code, account number, dates, amount, associated text such as “bank transfer to M. Doe” or “Check number 12345”, a form number used to print the account statement.

All of the transactions of a customer during one year, with the corresponding tags amount to a maximum of 32 KB.

The whole of this non-modifiable information, namely all the text type documents in the customer lifetime as well as all the account transactions for one year amount to 64 GB, which can easily be held in the hard disk of a simple microcomputer.

When there is a new document, or a new bank transaction, it is enough to add it at the end of the stored document representation table, which renders useless the use of pointers or all kinds of mapping tables that pose updating problems, and especially recovery in case of failure, for a simple coherence issue between the different information.

If one wants to display all the accounting documents of a customer during the last fifteen days from a workstation in an agency, one will proceed as follows:
From the workstation, one starts a query on a remote database to look for all operations corresponding to a given account number, between two predetermined dates.
In return, all the transactions, with contents and tags, as described above, are sent back through the internal bank network, from the database to the workstation, and may be displayed on screen.

If one wants to print an account statement using the form number used to print the bank statement, it will be possible to print an account statement identical to the one sent to the customer. As one may observe the ExtractData function may usefully be moved to a machine other than the one that contains the database.

One of the main advantage of this method, is that it is the same character sequence that appears in the database, and that is used at the end of the processing to print the document, and this character string is very compact, having as effect a lower network traffic.

To obtain response times compatible with the applications mentioned above, there are several possibilities that may be carried out independently from one another, or together, the aim being always to execute as fast as possible the StrStrEx function, and in particular the instruction sequence that allows to ignore the characters without interest as in the following example: if one looks for the “information” substring, one need to scan the string as fast as possible, while ignoring the typesetting tags, until the moment when one finds an uppercase or lowercase “I”, and when one has been bound, determine rapidly of the next useful character is an uppercase or lowercase “n”.

Among these different possibilities, one may cite: optimize the code in assembly language, use microprocessors that efficiently execute this kind of program because of the cache memory size or their ability to execute several instructions during a single clock cycle, use processors that work on 64 bits or more.

As it is shown on FIG. 5, one may use several Co-Pi microprocessors or computers in parallel each working on MEMi a part of the stored document representation table. For instance, one may associate to a simple microcomputer with 4 GB of memory, a card of type DSP32 equipped with 16 microprocessors each working in parallel on 1/16^{th} of the complete representation table.

Or use a microprocessor based on the FPGA (Field Programmable Gate Array) technology and create the succession of logical gates corresponding to the part of the StrStrEx function that must be executed very rapidly.

Another possibility is to use a microprocessor that is able, in a few clock cycles, to execute a sequence of several tens, hundreds or thousands that are not stored in the machine's memory, and loaded every time in the microprocessor cache memory, but hardwired at least in part in the microprocessor itself, in the way of specialized components such as graphic processors that allow fast display of a high resolution image.

According to the case, at least a part of the API library may, either be added to an existing microprocessor, allowing to obtain fast scanning with a simple microcomputer, for instance to perform searches in e-mail messages, or be moved in a separate microprocessor, called Co-Pi co-processor, that has access to the machine's memory, and executes instructions under the control of another master microprocessor MainProc, as does the graphic processor of a microcomputer (see FIG. 5).

Usefully, one may as well put in the microprocessor one or several dictionary tables, in order to accelerate the grammatical analysis of a document.

### APPENDIX

### Sample Code Written in the C Language for a Part of the StrStrEx Function

```
/*****
In the following example, one supposes that we are looking
for the string “lévrier”
  All displayable characters are in the range from 0×1 to
BALISE_MINI −1;
  All the tags are in the range from BALISE_MINI et
BALISE_MAXI, namely:
```

BALISE_MINI2 and BALISE_MAXI2 for 2 characters tags,
BALISE_MINI3 and BALISE_MAXI3 for 3 characters tags,
BALISE_SAME_CHAR is the tag for character substitution (to find
“lévrier” or “levrier”),
etc.

*****/

LPCSTR StrStrEx (LPCSTR ptrStart, LPCSTR ptrSubChain, UINT uiParameter, STRSTREX *strConvFormat)

{

strupr (ptrSubChain)
BYTE ucFirstCharUpr = ptrSubChain [0];
BYTE ucSecondCharUpr = ptrSubChain [1];
strlwr (ptrSubChain);
BYTE ucFirstCharLwr = ptrSubChain [0]
BYTE ucSecondCharLwr = ptrSubChain [1];
// very short loop to process most statistically frequent cases first,
// the aim is not to have compact code, but fast code
while (TRUE)
{

if ( *ptr ==0)

break;

if( *ptr < BALISE_MINI

&& *ptr != ucFirstCharLwr
&& *ptr != ucFirstCharUpr)

{

ptr++;
continue ; // -->caractère suivant

}
if ( *ptr == BALISE_SAME_CHAR)
{

ptr++; // advance one character to test next character
if ( *ptr != ucFirstCharLwr

&& *ptr != ucFirstCharUpr)

{

ptr++;
continue ;// -->next character
}

}
else if (*ptr <=BALISE_MAXI2)
{

ptr+=2; // advance 2 characters to test next character
continue;

}
else if (*ptr <= BALISE_MAXI3)
{

ptr+= 3; // advance 3 characters to test next character
continue;

}

// Ici, on a trouvé le premier caractère de la sous-chaîne
(‘I’ de “lévrier”)

if (ucSecondCharLwr !=0)// protection if the substring has more than
1 character

{
ptr++;
if ( *ptr == 0)
break;
if ( *ptr < BALISE_MINI

&& *ptr != ucSecondCharLwr
&& *ptr != ucSecondCharUpr)
{
ptr++;
continue; // -->next character
}

else if ( *ptr == BALISE_SAME_CHAR)
{
ptr++; // advance one character to test next character
if ( *ptr != ucSecondCharLwr

&& *ptr!= ucSecondCharUpr)
{
ptr++;
continue ; // -->next character

}

}
else if (*ptr <= BALISE_MAX12)
{
ptr+= 2; // advance 2 characters to test next character
continue ;
}
else if (*ptr <= BALISE_MAX13)
{
ptr+= 3; // advance 3 characters to test next character
continue ;
}

}

// ---- here, we have found the first characters of the substring (‘l’ in “lévrier”)---
// one may perform the same operation for the 3rd character, or do a loop.

1. Method for searching in documents stored in electronic memory, including the following steps:
selection of at least one document among the stored documents, from a query composed of at least one predetermined character string, then
extraction of a result in order to display it in the form of a preview of information related to the selected document, and
prior to the steps of selection and extraction, generation of a table representing the stored documents, containing a character string including at least a part of the information of the stored documents,
wherin, during the selection step, one generates the result with the help of the representation table, from information contained in the character string in the representation table found relevant according to the query.

2. Method for searching information according to claim 1, wherein, one compares the predetermined character string in the query with the character string in the representation table, notably by scanning sequentially the representation table, to select at least one document among the stored documents.

3. Method for searching information according to claim 1 or 2, wherein, at least one document being of e-mail message type and comprising several distinct sections chosen among the set constituted by a sender address, a recipient address, a header, a message body, and at least an attachment, the character string in the representation table contains at least a part of the text type information of each section of the e-mail message type document.

4. Method for searching information according to claim 2 and 3, wherein for the document of type e-mail message, one scans sequentially the information concerning the attachment before the information concerning any of the other sections of the document

5. Method for searching information according to any of the claims from 1 to 4, wherein the representation table character string moreover contains, for each stored document, identification information of this document.

6. Method for searching information according to any of the claims from 1 to 5, wherein one stores in memory at least a part of the result of the information search.

7. Method for searching information according to any of the claims from 1 to 6, wherein the part of the result of the information search stored in memory is stored in a file able to contain results from several searches.

8. Method for searching information according to any of the claims from 1 to 7, including, during the result extraction step, the following steps:
extraction of the information contained in the character string from the representation table found relevant according to the query,
transmission of this information to a remote terminal by the means of a data transmission network,
and wherein the display of the result is done by the remote terminal.

9. Method for searching information according to any of the claims from 1 to 8, wherein, during the generation step of the stored document representation table, one performs a conversion so that any displayable character in a text type area in the stored document is encoded:
Either on one byte;
Or with the help of a tag inserted in the representation table and followed by a code on one byte.

10. Method for searching information according to any of the claims from 1 to 9, wherein, during the generation step of the representation table, one inserts in the character string of the representation table at least one set of data delimited by at least one tag to supplement the information included in this character string.

11. Method for searching information according to claim 10, wherein each tag inserted in the character strings includes at least one escape character encoded on one byte not in the printable characters of the first 128 positions of the ASCII encoding table.

12. Method for searching information according to claim 10 or 11, wherein the set of data contains data to help in the presentation of the preview, used during the result extraction step.

13. Method for searching information according to any of the claims from 10 to 12, wherein the set of data contains data to help the selection of at least one document.

14. Method for searching information according to any of the claims from 10 à 13, wherein one inserts in the character string of the representation table at least one area of information of numerical type encoded on a predetermined number of bytes delimited by at least one tag indicative of this numerical area.

15. Method for searching information according to claim 14, wherein the tag indicating the numerical area is also a tag indicating a presentation convention of this numerical area.

16. Method for searching information according to any of the claims from 10 to 15, wherein, the stored documents being distributed in different types of document, one defines for each type of document a set of tags destined to be inserted in the character string of the representation table, each tag of this set having a meaning specific to this type of document.

17. Method for searching information according to any of the claims from 10 to 16, wherein one inserts in the character string of the representation table at least one set of data expressed in phonetic writing delimited by at least a tag of indication of phonetic writing.

18. Method for searching information according to any of the claims from 10 to 17, wherein one inserts in the character string of the representation table at least one tag indicating that a predetermined number of characters following that tag in the character string should not be scanned during the selection step.

19. Method for searching information according to any of the claims from 10 to 18, wherein one inserts in the character string of the representation table at least one set of data corresponding to a grammatical analysis of part of the contents of at least one stored document, delimited by at least one tag of indication of grammatical analysis.

20. Method for searching information according to any of the claims from 10 to 19, wherein one inserts in the character string of the representation table at least one set of data corresponding to metadata describing a part of the contents of at least one stored document, delimited by at least one tag of indication of metadata.

21. Method for searching information according to any of the claims from 10 to 20, wherein one inserts in the character string of the representation table at least one tag to start a predetermined program.

22. Method for searching information according to any of the claims from 1 to 21, wherein:
Each stored document containing information distributed in several distinct predetermined sections common to all stored documents, the result is displayed in the form of a preview including a preview zone for each distinct common section and comprising a list of initially selected documents for the information they contain found relevant according to the query.
Each preview zone may be disabled, and
When one disables at least one preview zone, one maintains only in the displayed list each document initially selected for information found relevant that this document contains in at least one section corresponding to at last one zone that remains enabled.

23. Search engine for searching for information in documents stored in electronic memory, including:
Means of generation of a stored document representation table, this table containing a character string comprising at least a part of the stored document information.
Means of selection of at least one document among the stored documents, from a query containing at least one predetermined character string.
wherin it comprises means of extraction of a result with the help of the representation table, from information contained in the character string of the representation table found relevant according to the query, in order to display this result in the form of a preview of information relative to the selected document.

24. Microprocessor including instructions programmed for the implementation of a method for searching information according to any of the claims from 1 to 22.

25. Microprocessor according to claim 24, also including means of storage of at least one dictionary table containing a set of words in a predetermined language, each word being associated in this dictionary table to grammatical analysis data
